(19) United States
(12) Patent Application Publication
(10) Pub. No.: US 2005/0248447 A1
(43) Pub. Date: Nov. 10, 2005

(54) Thermoelectric tire pressure monitor sensor

(76) Inventors: Majdi Yaqub, Rochester Hills, MI (US); Tom Tang, Novi, MI (US); Riad Ghabra, Dearborn Heights, MI (US); John Nantz, Brighton, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/842,378

(22) Filed: May 10, 2004

(51) Int. Cl. B60C 23/00

(52) U.S. Cl. 340/443

(57) ABSTRACT

A batteryless tire pressure sensing device includes a sensing module disposed within a tire for sensing at least one pressure-related parameter of said tire. A thermoelectric module is provided for converting heat into electrical energy for energizing the sensing module. The thermoelectric module includes a first thermal conductive substrate exposed to a first temperature and a second thermal conductive substrate exposed to a second temperature. The heat conversion is generated between the first thermal conductive substrate and the second thermal conductive substrate in response to rotational movement of the tires.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates in general to tire pressure monitoring sensors, and more specifically, to a batteryless tire pressure monitoring sensor.

2. Description of the Related Art

Tire pressure monitoring (TPM) systems include disposing pressure sensors on or within vehicle tires to sense the pressure within a respective tire and report low pressure conditions to a driver. Various systems have mounted sensors inside the tires on a portion of the rubber, the rim of the wheel, on a valve stem within a wheel, or on the valve stem outside of the wheel. TPM systems sense tire pressure within a tire and transmit a signal to a receiving unit located external to the tire for processing tire pressure data. A power source is required to energize the sensor and other electrical components of the TPM within the tire. Other electrical devices may include a transmitter if the data sensed is being wirelessly transmitted to a nearby receiver.

Many TPM systems utilize a battery as the power source for energizing the electrical components within the TPM system. However, typical storage batteries have a finite life and require periodic replacement. The longer the activation time of a respective TPM, the shorter the useful life of a respective battery. For TPM sensors located external to the tire, batteries may be easily replaced or recharged. However, TPM systems incorporating TPM systems external to tire are directly exposed to and affected by exterior environment conditions and road conditions.

For TPM systems located internally to the tire and utilizing a battery as the power source, these systems typically require dismounting the tire from the vehicle and removing the tire from the rim so as to access the TPM sensor to replace or recharge the battery. This requires cost, time, and effort.

For systems utilizing TPM sensors internal to the tire, these systems place the TPM electronics into a dormant state when not in use and activate the TPM system only when needed so as to conserve energy and extend the life of the battery. However, this only extends the life of the finite power source and at some future point in time requires changing the battery. What would be useful is a maintenance free TPM system that includes a power source which requires neither replacement nor recharging.

### SUMMARY OF THE INVENTION

The present invention has the advantage of using a thermoelectric generator disposed within a tire for providing electrical energy to a TPM device also disposed within the tire wherein the electric energy is generated in response to a heat differential between two conductive substrates of the thermoelectric generator. The heat differential is produced in response to the rotation of a tire (i.e. thermal energy created by friction) by exposing a first conductive substrate to the internal air of the tire whereas the second conductive substrate is thermally attached to a valve stem cooled by external air.

A batteryless tire pressure sensing device of the invention includes a sensing module disposed within a tire for sensing at least one pressure-related parameter of said tire. A thermoelectric module is provided for converting heat into electrical energy for energizing the sensing module. The thermoelectric module includes a first thermal conductive substrate exposed to a first temperature and a second thermal conductive substrate exposed to a second temperature. The heat conversion is generated between the first thermal conductive substrate and the second thermal conductive substrate in response to rotational movement of the tires.

### BRIEF DESCRIPTION OF THE DRAWINGS

FIG. 1 is a block diagram illustrating a TPM sensor of the present invention.

FIG. 2 is an illustration of a portion of a thermoelectric generator for converting heat to electrical energy according to the present invention.

FIG. 3 is a perspective view of the thermoelectric generator of the present invention.

FIG. 4 is a perspective view of a tire pressure monitor of the present invention.

FIG. 5 is a perspective view of a housing portion for the tire pressure monitor of the present invention.

FIG. 6 is a perspective view of a valve stem integrating the thermoelectric generator of the present invention.

FIG. 7 is a cross sectional view of the tire pressure monitor according to the present invention.

FIG. 8 illustrates a flowchart of a method for providing electrical energy to a TPM system of the present invention.

### DETAILED DESCRIPTION OF PREFERRED EMBODIMENTS

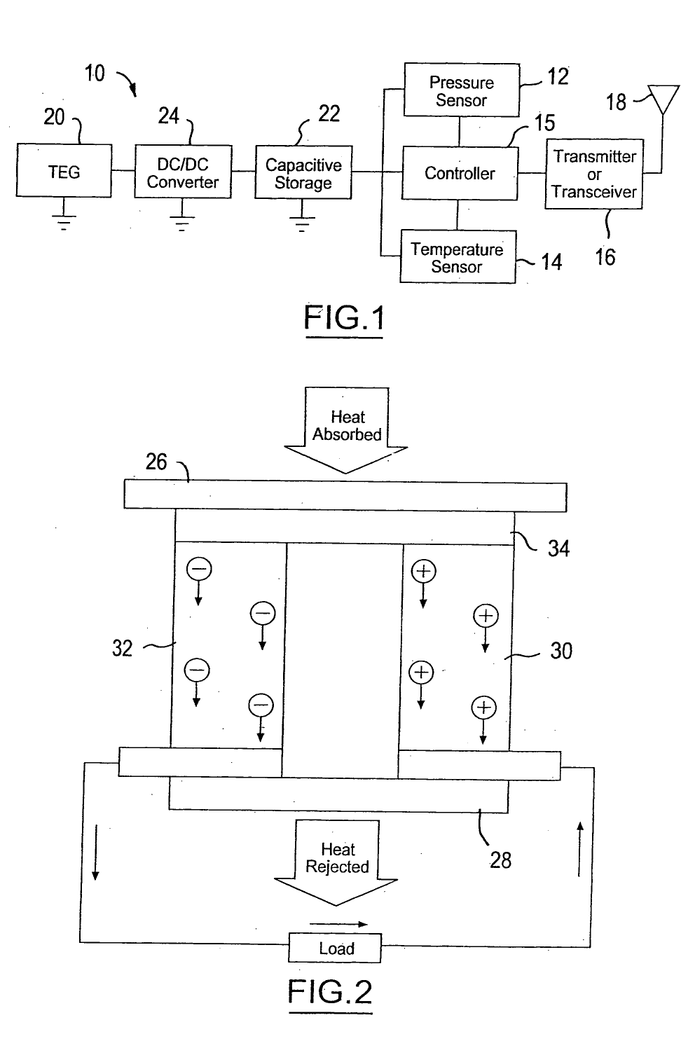

Referring now to the Drawings and particularly to FIG. 1, there is shown a block diagram of a batteryless thermoelectric tire pressure monitoring (TPM) sensor 10. The TPM sensor 10 is mounted within the interior portion of the tire (e.g. to the interior of a wheel rim). The TPM sensor 10 includes at least one sensor for sensing a pressure-related parameter of a tire for determining the air pressure within in the tire. In the preferred embodiment, a pressure sensor 12 is included for sensing the air pressure within the tire. The pressure within an entrapped volume such as a tire may have expansion or contraction properties dependent on the temperature of the air within the tire. Therefore, a temperature sensor 14 is included within the TPM sensor 10 for taking into account the affect the temperature will exhibit on the pressure within the tire.

Since the TPM sensor 10 is disposed within the interior portion of the tire, a wireless communication means is utilized to radiate data signals between the TPM sensor 10 and an exterior receiving device located elsewhere within a vehicle for processing the data. A controller 15 is connected to the pressure sensor 12 and the temperature sensor 14 for retrieving sensed data from both sensors and processing the sensed data. The controller 15 is connected to a transmitter 16 for radiating wireless data via an antenna 18 including the sensed pressure data and temperature data to an exterior receiving device for determining whether the tire pressure is within a normal operating range. To conserve power, the transmitter may only be activated when an abnormal pressure is sensed. Transmitter 16 can be programmed to additionally transmit the pressure data at regular intervals (e.g. once per driving cycle). Alternatively, a transceiver or a transmitter-receiver may be used to receive an interrogating signal from a vehicle controller and to transmit the data in response to the interrogating signal.

A power supply is required to supply electrical energy to the pressure sensor 12 and the temperature sensor 14, controller 15, as well as the transmitter 16. A typical TPM sensor consumes about 3V, 10 mA for 15-20 mSec during a transmitting mode, about 3V, 10 microA in a stand-by mode, and about 2250-2400 micro Joule every 60 sec during power up of the electrical circuit. A thermoelectric generator 20 is disposed within the tire for generating electrical energy. The thermoelectric generator 20 is a power source that converts heat to electrical energy, and unlike a battery or other capacitive storage device which includes a finite exhaustive energy source, the thermoelectric generator 20 can continuously generate electrical energy. A source of heat required for the conversion to electrical energy is provided by the rotation of the tires. A DC to DC converter 24 may be utilized if necessary for increasing the voltage to a level required by the loads. Also included is an energy storage device 22 for storing excessive electrical energy output of the thermoelectric generator 20 or the DC to DC converter 24. The preferred embodiment uses a 0.22 F capacitor, although, in other preferred embodiments different sized capacitors may be used. Furthermore, other energy storage devices may be utilized such as a re-chargeable battery or like devices.

FIG. 2 shows a thermoelectric generator illustrating the thermal transfer of heat and electrical energy flow to a respective load. A P-type semiconductor element 30 and an N-type semiconductor element 32 are disposed between a first thermal conductive substrate 26 (i.e., cold side) and a second thermal conductive substrate 28 (i.e., hot side). Both the N-type and P-type semiconductor are alloys made of Bismuth and Tellurium and have different free electron densities when at a same temperature. The P-type semiconductor 30 has a deficiency of electrons while the N-type semiconductor has an excess of electrons. The first thermal conductive substrate 26 and the second thermal conductive 28 are made of a conductive metal such as copper or aluminum. To generate current flow, the first thermal conductive substrate 26 is exposed to region of higher temperatures than the second thermal conductive substrate 28. A metallic interconnect 34 electrically connects a top portion of the P-type semiconductor element 30 with a top portion of an adjacent N-type semiconductor element 32. Additional P-type and N-type regions (not shown) are connected in series an alternating manner, a bottom portion of the N-type semiconductor element 32 being electrically connected via a next metallic interconnect to a bottom portion of a next adjacent P-type semiconductor element (not shown). Likewise, a bottom portion of the P-type semiconductor element 30 is electrically connected by a respective metallic interconnect to a bottom portion of a next adjacent N-type semiconductor element (not shown).

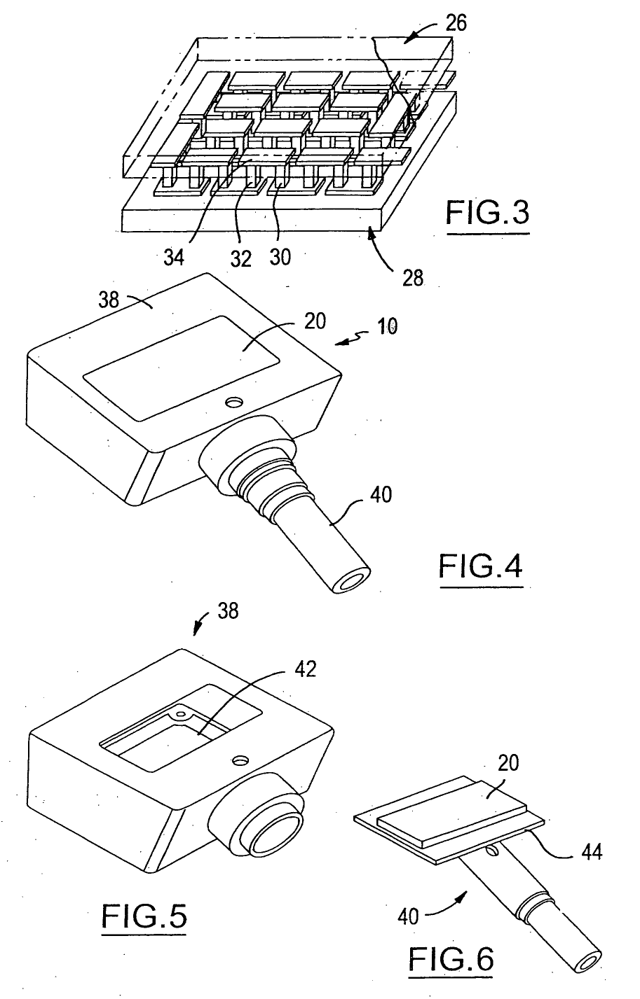

FIG. 3 illustrates an array of P-type and N-type semiconductor elements comprising the thermoelectric generator. The array of P-type and N-type semiconductor elements are electrically connected in series via a plurality of metallic interconnects and are thermally connected in parallel via the conductive substrates. The plurality of metallic interconnects interconnecting each top portion of the semiconductor elements are affixed to the first thermal conductive substrate 26, and the plurality of metallic interconnects interconnecting each bottom portion of the semiconductor elements are affixed to the second thermal conductive substrate 28.

To transform a heat differential into electrical energy, the first thermal conductive substrate 26 is exposed to a heat source. A surface of the first thermal conductive substrate 26 exposed to the heat source is known as the cold side, whereas a surface of the second thermal conductive substrate 28 opposite the semiconductor elements is known as a hot side. Electrons are capable of moving freely within the electrical interconnect, but are not as free to move within in the semiconductor elements. To move between the second thermal conductive substrate 28 and the first thermal conductive substrate 26 using a respective set of p-type and n-type semiconductor elements, an electron must fill a hole to move within the respective p-type semiconductor. As the electron exits a respective metallic interconnect (i.e., on the hot side) and enters the hot side of the respective p-type semiconductor, the electron fills the hole within the p-type semiconductor. Holes essentially move within the p-type semiconductor (i.e., without an electron) from the cold side to the hot side. As the electrons fills the hole, the electron drops down to a lower energy level, thereby releasing heat in the hot side of the thermal electric generator 20. As the electron ascends to the top portion of the respective p-type semiconductor (i.e., cold side), the electron transitions to a next respective metallic interconnect. During the transition, the electron is elevated back to a higher energy level and heat from the heat source is absorbed by the electron. Once in the next respective metallic interconnect, the electron travels to the N-type semiconductor. When transitioning to the N-type semiconductor from the next respective metallic interconnect, the electron must elevate to a next higher energy level to travel through the N-type semiconductor. As a result, heat from the heat source is again absorbed in the electron. As the electron transitions from the N-type semiconductor element to a next bottom metallic interconnect of the hot side, the electron drops down to a lower energy level and releases heat in the hot side. As a result, heat is absorbed at the cold side of the N-type and P-type interconnections while heat is always discharged at the hot side of the N-type and P-type interconnections.

A closed electrical loop is formed when a load is added in series to the thermoelectric generator (shown in FIG. 1) and a constant flow of electrons will continuously move through each transition area (i.e. junction) if there is an energy level differential between each set of semiconductors. The semiconductor with the higher energy electrons will transition across each junction until the energy level is the same on both sides of a respective junction. If both conductive substrates are consistently at different temperatures, then an unequal number of electrons will be present at each junction and the unequal number of electrons will continuously cross each junction attempting to equalize the energy levels. As a result, unequal voltages are established which results in a net voltage around the loop, which results in current flow. It is known that the rate of heat transfer is proportional to the current.

To maintain current flow, a significant temperature difference must be maintained between the first conductive plate 26 and the second conductive plate 28, otherwise the electrons transitioning between the two sides will result in equal energy levels and temperature levels between a respective set of semiconductors and conductive plates, respectively. As a result, the source of the heat must be a viable and substantially constant heating source and the hot side must be able to dissipate the heat so that the discharged heat on the hot side does not increase to the same temperature as the heat source, otherwise, heat transfer will cease to occur resulting in no current flow.

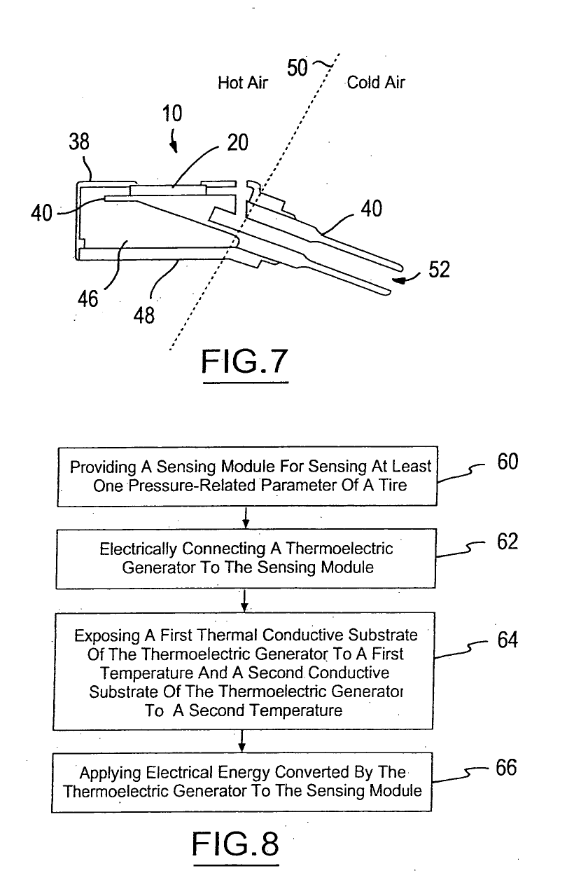

FIG. 4 illustrates the batteryless TPM sensor 10 utilizing the thermoelectric generator 20 as an electrical power source. The TPM sensor 10 includes a tire valve stem 40 which protrudes exterior to a wheel of a vehicle for pressurizing an inflatable tire. The thermoelectric generator 20 is integrated within a housing portion 38. The housing portion 38 is disposed within the interior of the tire. An electrical circuit board 48 (shown in FIG. 7) is disposed within the housing portion 38. The electrical circuit board 48 includes the pressure sensor 12, the temperature sensor 14, the transmitter 16, the antenna 18, the energy storage device 22, and the DC converter 24. FIG. 5 illustrates the housing portion 38. A window portion 42 is disposed through a top surface of the housing portion 38. The thermal generator 20 is disposed within the window portion 38 for exposing the pressurized heated air within the tire to the thermal generator 20. FIG. 6 shows the thermal generator 20 disposed on the surface of a cooling plate 44. The cooling plate 44 and the tire valve stem 40 are formed as a single component. Alternatively, the cooling plate and the tire valve stem 40 may be individual components thermally coupled to one another.

FIG. 7 illustrates a side cross-sectional view of the TPM sensor 10. The partition wall shown generally at 50 is representative of a wall of a wheel/tire rim. The tire valve stem 40 protrudes through the wheel/tire 50 and is exposed to air exterior to the wheel/tire 50. The housing portion 38 is disposed within the wheel/tire 50 and is exposed to the pressurized air within the wheel/tire 50. An air passageway 52 is provided to inflate the tire with pressurized air. The thermoelectric generator 20 is disposed within the window portion 42 and is exposed to the pressurized air of the wheel/tire 50. When the wheel/tire 50 is rotated, the temperature within the wheel/tire 50 increases to an elevated temperature which is the heat source for the thermoelectric generator 20. As a result, the first conductive plate 26 is exposed to the heat source. The heat from the heat source is converted to electrical energy as discussed supra. The cooling plate 44 being part of, or thermally attached to, the tire valve stem functions as a heat sink to dissipate heat absorbed by the second conductive plate 28 to maintain a temperature difference between the first conductive plate 26 and the second conductive plate 28. The exterior air passing over the tire valve stem 40 as a result of the movement of the vehicle as well as the rotation of the wheel/tire 50 cools the tire valve stem 40. In addition, since the cooling plate 44 is integral to the tire valve stem 40, the heat absorbed by the second conductive plate 28 dissipated by this cooling effect. An isolation potting material 46 is deposited within the interior portion of the housing 10 to thermally isolate the cooling plate from the interior pressurized air of the wheel/tire 50. The isolation potting material 46 thermally isolates the cooling plate 44 which further assists in maintaining a continuous and significant temperature difference between the two conductive plates during vehicle motion. The greater the temperature difference between the two conductive plates the greater the rate of heat transfer, which is in turn, proportional to the flow of current.

FIG. 8 illustrates a method of providing electrical energy to the sensing module disposed within the interior of the tire. In step 60, a sensing module is provided for sensing at least one pressure-related parameter of a tire. Such parameters may include air pressure and temperature within the tire. In step 62, a thermoelectric generator is electrically attached to the sensing module for providing electrical energy to the electrical components of the sensing module. The DC to DC converter may be electrically connected in parallel to the thermoelectric generator for increasing the voltage. The storage capacitive device may also be electrically connected in parallel with the thermoelectric generator or the DC-to-DC converter for storing excess electrical energy generated by the thermoelectric generator. In step 64, the first thermal conductive substrate of the thermoelectric generator is exposed to the first temperature (i.e., heat source). The second thermal conductive substrate of the thermoelectric generator is exposed to the second temperature where the first temperature is substantially higher than the second temperature. The thermoelectric generator converts the heat transferred between the first conductive substrate and the second conductive substrate to the to electrical energy. In step 66, the electrical energy converted by the thermoelectric generator is provided to the sensing module for powering such devices such as the pressure sensor, the temperature sensor, and the transmitter.

1. A batteryless tire pressure sensing device comprising:
a sensing module disposed within a tire for sensing at least one pressure-related parameter of said tire; and
a thermoelectric module converting heat into electrical energy for energizing said sensing module, said thermoelectric module including a first thermal conductive substrate exposed to a first temperature and a second thermal conductive substrate exposed to a second temperature;
wherein said heat conversion is generated between said first thermal conductive substrate and said second thermal conductive substrate in response to rotational movement of said tires.

2. The sensing device of claim 1 wherein said first thermal conductive substrate is exposed to an internal air mass within said tire.

3. The sensing device of claim 1 further comprising a cooling plate thermally attached to said second conductive substrate for dissipating heat within said second conductive substrate.

4. The sensing device of claim 3 wherein said cooling plate is integral to a tire valve stem for dissipating said heat of said second conductive substrate.

5. The sensing device of claim 3 wherein said cooling plate is thermally affixed to a tire valve stem for dissipating said heat of said second conductive substrate.

6. The sensing device of claim 3 further comprising an isolation potting material about said cooling plate for isolating said cooling plate from said internal air mass within said tire.

7. The sensing device of claim 1 wherein said sensing module comprises an energy storage device for storing said electrical energy generated by said thermoelectric module.

8. The sensing device of claim 7 wherein said energy storage device includes a capacitor.

9. The sensing device of claim 1 wherein said sensing module comprises a transmitter, said transmitter transmits wireless data relating to said sensed parameter of said tire.

10. The sensing device of claim 1 wherein said sensing module comprises a transceiver, said transceiver receives an interrogation signal and transmits wireless data relating to said sensed parameter of said tire in response to said interrogation signal.

11. The sensing device of claim 1 wherein said sensing module comprises a DC to DC converter for regulating said electrical energy.

12. The sensing module of claim 1 wherein said sensing module comprises at least one sensor for sensing said at least one parameter of said tire.

13. The sensing module of claim 12 wherein said at least one sensor comprises a pressure sensor.

14. The sensing device of claim 12 wherein said at least one sensor comprises a temperature sensor.

15. A method for providing electrical energy to a tire pressure sensing device, the method comprising the steps of:
providing a sensing module for sensing at least one parameter of a tire;
electrically connecting a thermoelectric generator to said sensing module;
exposing a first thermal conductive substrate of said thermoelectric generator to a first temperature responsive to thermal energy generated by tire movement and a second thermal conductive substrate of said thermoelectric generator to a second temperature, said first temperature being higher than said second temperature; and
applying electrical energy generated by said thermoelectric generator to said sensing module.

16. The method of claim 15 wherein said first thermal conductive substrate is exposed to an internal air mass within said tire.

17. The method of claim 16 further comprising the step of thermally attaching said second conductive substrate to a cooling plate for dissipating heat within said second conductive substrate.

18. The method of claim 17 further comprising the step of providing a tire valve stem integral to said cooling plate for dissipating said heat of said second conductive substrate.

19. The method of claim 17 further comprising the step of thermally affixing said cooling plate to a tire valve stem for dissipating said heat of said second conductive substrate.

20. The method of claim 17 further comprising the step of providing an isolation potting material about said cooling plate for isolating said cooling plate from said internal air mass within said tire.
